(19) United States
(12) Patent Application Publication
(10) Pub. No.: US 2024/0384112 A1
(43) Pub. Date: Nov. 21, 2024

(54) Composition With Antimicrobial Properties, In Particular Biocidal Properties, for Surface Coatings of Wood-Based Panels

(71) Applicant: SWISS KRONO Tec AG, Luzern (CH)

(72) Inventors: Andreas Gier, Mandelbachtal (DE); Joachim Hasch, Berlin (DE); Norbert Kalwa, Horn-Bad Meinberg (DE)

(21) Appl. No.: 18/689,194

(22) PCT Filed: Sep. 2, 2022
(86) PCT No.: PCT/EP2022/074450

§ 371 Date: Mar. 5, 2024

(30) Foreign Application Priority Data
Sep. 6, 2021 (EP) 21195074.6

(51) Int. Cl. C09D 5/14; A01N 31/08; A01N 33/12; A01N 43/16; A01N 59/20; A01P 1/00; C08K 3/36; C08K 5/06; C08K 5/5419; C09D 7/61; C09D 7/63; C09D 167/02; C09D 175/04; C09D 183/04; C09J 11/04; C09J 11/06

(52) U.S. Cl. CPC C09D 5/14; A01N 31/08; A01N 33/12; A01N 43/16; A01N 59/20; A01P 1/00; C09D 7/61; C09D 7/63; C09D 167/02; C09D 175/04; C09D 183/04; C09J 11/04; C09J 11/06; C08K 3/36; C08K 5/06; C08K 5/5419

(57) ABSTRACT

The present invention relates to a composition having antimicrobial properties, in particular antiviral properties, as an additive for surface coatings of substrates. The composition includes at least one polyol or a glycol ether; at least one compound of the general formula (I) R¹ₐ SiX^{(4-a)}, where X is alkoxy, and R¹ is an organic moiety selected from the group including alkyl, cycloalkyl, or phenyl and a=1, 2, 3, in particular 1 or 2; at least one compound of the general formula (II) SiX₄, where X is alkoxy; and at least one antimicrobial active ingredient, in particular at least one biocide.

### CROSS REFERENCE TO RELATED APPLICATIONS

This application is the United States national phase of International Patent Application No. PCT/EP2022/074450 filed Sep. 2, 2022, and claims priority to European Patent Application No. 21195074.6 filed Sep. 6, 2021, the disclosures of which are hereby incorporated by reference in their entireties.

### BACKGROUND OF THE INVENTION

### Field of the Invention

The present invention relates to a composition with antimicrobial properties, in particular biocidal properties, as an additive for surface coatings on material boards, a lacquer and a hot-melt adhesive containing this composition, the use of this composition and wood-based material boards coated therewith.

### Description of Related Art

In almost all areas of everyday life, the user encounters surfaces that are coated to improve their usage properties, enhance their haptic properties, improve their appearance, etc. For example, wood-based panels and elements with a lacquered surface are used in various areas of furniture, floor coverings and interior fittings.

However, these surface coatings cannot always be regarded as optimal in terms of their hygienic properties. This often has to do with the choice of material itself, but also with the design specifications of the designers, etc. However, all this is in contrast to the fact that the issue of hygiene/disinfection is playing an increasingly important role in public perception. It should also be noted that the range of surfaces in terms of their disinfectability is considerable.

While a melamine surface can be disinfected easily, quickly and frequently without surface changes occurring, this is often not the case for high-gloss lacquered fronts. When using disinfectants, surface changes such as shining or streaking can occur. These can be caused by the chemically aggressive disinfectants in general or by an application that does not comply with the manufacturer's specifications.

Disinfectant applications by untrained personnel are to be regarded as critical, especially for more sensitive surfaces, as they are not informed about the exact conditions of application (application quantities, application conditions, etc.). In addition, the preparations that have to be used are not harmless to health and should therefore only be used by trained personnel. In addition, the repeated application at regular intervals leads to downtime. These repeated applications naturally also lead to higher costs.

Approaches for carrier materials that are not based on wood-based materials are already known.

An example of a long-term stable, microbicidal coating for plastics or metals is described in DE 10 2008 051 543 A1. The coating cited here comprises an organic microbiocidal compound and a condensate of an organosilane with hydrolytically non-cleavable groups and a hydrolyzable silane. Glycidyloxypropyltrimethoxysilane and tetraethoxysilane are cited as preferred examples. Hydrolyzable metal or boron compounds such as Al(OCH₃)₃, Tl(OC₃H₇)₄ or B(OC₂H₅)₃ may also be included. The disadvantage is that this coating composition is not compatible in terms of process safety. These are ethanol/methanol-based coatings, which may be water-miscible, but there are problems with regard to explosion protection/toxicity (methanol) and emission protection DE 10 2006 001 641 A1 describes a substrate with biocidal and antimicrobial properties, whereby an inorganic compound consisting of a metal or semi-metal is first applied to a substrate (such as a knitted fabric, woven fabric, non-woven fabric or paper). After drying, a first coating of an organosilane (e.g. glycidyloxypropyltrimethoxysilane) with oxide particles is applied, followed by a further coating of an organosilane with a biocidal substance containing zinc or silver.

However, these previously known approaches have various disadvantages. For example, these systems can only be used to a limited extent in paints or hot-melt adhesives or contain silver-containing salts, which have proven to be hazardous to health and problematic for the environment.

### SUMMARY OF THE INVENTION

The invention is therefore based on the technical object of providing a surface lacquer and/or a hot-melt adhesive suitable for the surface coating with an antiviral active ingredient for wood-based materials that does not have these disadvantages. The active ingredients should be harmless to health and be easy to incorporate into the lacquer. The formulations should also be processed on the application units normally used. The quality of the surface in terms of mechanical and chemical resistance should not be affected.

According to the invention, this object is solved by a composition having the features described herein.

Accordingly, a composition with antimicrobial properties, in particular antiviral properties, is provided as an additive for transparent surface coatings of substrate materials provided with a decor, in particular wood-based panels, wherein the composition comprises:
at least one polyol or one glycol ether;
at least one compound of the general formula (I)

R¹ₐSiX₍₄₋ₐ₎ (I),
whereby
X is alkoxy, and
R¹ is an organic moiety selected from the group consisting of alkyl, cycloalkyl, or phenyl and
a=1, 2, 3, in particular 1 or 2,
at least one compound of the general formula (II)

SiX₄ (II),
where X is alkoxy, and
at least one antimicrobial active ingredient, in particular at least one biocide.

The present composition enables the incorporation or embedding of biocidal active ingredients into a lacquer matrix, such as a final surface lacquer, or a hot-melt adhesive, such as a PUR hot-melt adhesive, which are applied to surfaces of carrier materials such as wood-based panels. For this purpose, the present composition comprises at least one silane compound of the general formula (I) and a further silane compound of the general formula (II). The silane compound of formula (I) binds to the antimicrobial agent via the organic residue. The silane compound of formula (II) is used to build up a SiO₂. network via condensation of the OH groups, binding to polyol/glycol ether and the antimicrobial active ingredient. The biocidal active ingredient is coupled to the silanes. The complex of active ingredient and silane can then be firmly integrated into the coating agent. Polyols are also a component of the PU hotmelt adhesive and can therefore be chemically bonded. The alkyl groups, such as methyl, of the silane compound of formula (I) cause a “loosening” of the three-dimensional SiO₂ network, which is formed by condensation. More flexible network structures are formed that are not too brittle.

In particular, the present composition, or a lacquer system containing the composition, is preferably applied to cellulose-containing surfaces and materials, in particular wood-based panels, but not textiles. It is also possible to apply the composition to glass or films. It should be noted that the present composition is not applied to leather-containing, metal- or semi-metal-containing coatings, surfaces or materials and is also not suitable and intended as an additive for surface coatings of such materials.

The present composition can be added as an additive to lacquer formulations, in particular in surface lacquer or top lacquer, or hot melt adhesives used for coating wood-based panels. The virally active component is added to the top lacquer or the hot melt adhesive depending on the amount required.

In particular, it has been surprisingly found that the present antimicrobially active composition can be added as an additive to the mentioned surface coatings (in particular lacquers and hot melt adhesives) without causing segregation or precipitation or the like of the additive. In view of the limited number of ingredients in the composition, this was not to be expected.

It should also be emphasized that the surface coatings used here are preferably applied to decors provided on the carrier materials. Accordingly, the surface coating should be transparent. This in turn means that the present antimicrobial composition should also be as transparent as possible in order not to impair the optical properties of the surface coating.

A variety of motifs can be used as decors, whereby the decors are provided in direct printing (digital printing or gravure printing) or as decor papers on the carrier materials.

The use of the present composition offers various advantages. For example, embedding the active ingredient in the lacquer or hot-melt adhesive matrix results in permanent antimicrobial protection; it is difficult or impossible for the active ingredient to wash out. Disinfection costs are also reduced, as the active ingredient is only applied once to the surface layer; repeated application of a disinfectant can be avoided.

In one embodiment, the present composition may comprise at least one further compound of the general formula (III)

R²SiX₃ (III),

whereby
X is alkoxy, and
R¹² is an organic moiety selected from the group comprising C1-C10 alkyl, which may be interrupted by —O— or —NH—, and
wherein R¹ comprises at least one functional moiety Q₁ selected from a group comprising a methacrylic, methacryloxy, vinyl and epoxy group.

It should be noted that the present composition does not contain any other silanes or any other silicon-containing compounds, such as silicates or silicon-containing resins or oils, in addition to the silanes of formulae (I), (II) and (III) mentioned. Likewise, no metals or metal oxides, such as TiO₂ or the like, are contained in the composition. The addition of further organic solvents such as cyclohexane, xylene, acetylacetate etc. and other low-boiling solvents and surface-active substances such as surfactants is also dispensed with.

Rather, the present composition is preferably limited to four or five components: silane of formula (I), silane of formula (II), optionally silane of formula (III), poylol or glycol ether, and antimicrobial agent. Only additional ions from acids (see below) or bases (for neutralization) used during manufacture may be present, but these are not essential for the effectiveness of the additive composition.

The hydrolyzable moiety X is advantageously selected from a group comprising C₁₋₆-alkoxy, in particular methoxy, ethoxy, n-propoxy, i-propoxy and butoxy.

The organic moiety R¹ of the compound of the general formula (I) is preferably selected from a group comprising C1-C10 alkyl, preferably C1-C8 alkyl, in particular preferably methyl, ethyl, propyl, pentyl, hexyl, heptyl, octyl. The term “cycloalkyl” comprises the groups cyclopropyl, cyclobutyl, cyclopentyl, cyclohexyl and cycloheptyl.

The compound of the general formula (I) may in particular comprise one of the following formulae: R¹SiX₃ or R¹₂SiX₂ with R¹ as C1-C10 alkyl group, preferably methyl, ethyl, propyl, pentyl, hexyl, heptyl, octyl, and with X as alkoxy, in particular methoxy, ethoxy, n-propoxy or i-propoxy.

In one variant of the present composition, compounds of the general formula (I) according to R¹ₐSiX₍₄₋ₐ₎, in particular R¹SiX₃, may be selected from methyltriethoxysilane, phenyltriethoxysilane, dimethyldiethoxysilane, octyltriethoxysilane.

In a particularly preferred variant of the present composition, the compound of the general formula (II) SiX₄ comprises methoxy, ethoxy, n-propoxy or i-propoxy and butoxy, as X. Particularly preferred are the compounds tetramethoxysilane and tetraethoxysilane as the compound of the general formula (II).

The organic R² of the compound of the general formula (III) is preferably selected from a group comprising methyl, ethyl, propyl, pentyl, hexyl, heptyl, octyl, which may be interrupted by —O— or —NH—.

In one embodiment of the present composition, the at least one functional group Q¹ of the compound of general formula (III) is selected from a group comprising epoxy, methacryloxy, amino, and vinyl. A particularly preferred functional moiety Q¹ is glycidyloxy. The functional moiety Q¹ advantageously has a moiety with a double bond or an epoxide group which can be activated and polymerized by means of UV radiation.

In a particularly preferred variant of the present composition, the compound of general formula (III) comprises methoxy, ethoxy, n-propoxy or i-propoxy and butoxy, as X.

Particularly preferred are the compounds glycidyoxypropyltriethoxysilane and glycidyoxypropyltrimethyoxysilane as a compound of the general formula (III).

The glycol ethers used are dipropylene glycol monomethyl ether, tripropylene glycol monomethyl ether, 1-methoxy-2-propanol, tripropylene glycol monobutyl ether, propylene glycol butyl ether and ethylene glycol monophenyl ether.

The polyols used are polybutadiene diol, polyethylene glycol, polypropylene glycol and propane-1,2,3-triol.

In a preferred embodiment, the present composition comprises
at least one glycol ether,
at least one compound of the general formula (I) according to R¹SiX₃ or R¹₂SiX₂ with R¹ as C1-C10 alkyl group, preferably methyl, ethyl, propyl, pentyl, hexyl, heptyl, octyl, and with X as alkoxy, in particular methoxy, ethoxy, n-propoxy or i-propoxy;
at least one compound of the general formula (II) according to SiX₄ with X as methoxy, ethoxy, n-propoxy or i-propoxy and butoxy; and
at least one antimicrobial active ingredient, in particular at least one biocide.

In a further preferred embodiment, the present composition comprises
at least one glycol ether,
at least one compound of the general formula (I) according to R¹SiX₃ or R¹₂SiX₂ with R¹ as C1-C10 alkyl group, preferably methyl, ethyl, propyl, pentyl, hexyl, heptyl, octyl, and with X as alkoxy, in particular methoxy, ethoxy, n-propoxy or i-propoxy;
at least one compound of the general formula (II) according to SiX₄ with X as methoxy, ethoxy, n-propoxy or i-propoxy and butoxy;
at least one compound of the general formula (III) according to R²SiX₃ with R² as methyl, ethyl, propyl, pentyl, hexyl, heptyl, octyl, which may be interrupted by —O— or —NH—, and functionalized with an epoxide or vinyl moiety as Q1, and X as methoxy, ethoxy, n-propoxy, i-propoxy or butoxy; and
at least one antimicrobial active ingredient, in particular at least one biocide.

In a still further embodiment, the present composition comprises
at least one polyol,
at least one compound of the general formula (I) according to R¹SiX₃ or R¹₂SiX₂ with R¹ as C1-C10 alkyl group, preferably methyl, ethyl, propyl, pentyl, hexyl, heptyl, octyl, and with X as alkoxy, in particular methoxy, ethoxy, n-propoxy or i-propoxy;
at least one compound of the general formula (II) according to SiX₄ with X as methoxy, ethoxy, n-propoxy or i-propoxy and butoxy; and
at least one antimicrobial active ingredient, in particular at least one biocide.

In particularly preferred embodiments, the present composition comprises;
at least one glycol ether,
at least one compound of the general formula (I) according to R¹SiX₃ or R¹₂SiX₂ with R¹ as methyl, ethyl, propyl, and with X as methoxy, ethoxy;
at least one compound of the general formula (II) according to SiX₄ with X as methoxy, ethoxy, and
at least one antimicrobial active ingredient, in particular at least one biocide.

Or
at least one glycol ether,
at least one compound of the general formula (I) according to R¹SiX₃ or R¹₂SiX₂ with R¹ as methyl, ethyl, propyl, and with X as methoxy, ethoxy;
at least one compound of the general formula (II) according to SiX₄ with X as methoxy, ethoxy;
at least one compound of the general formula (III) according to R²SiX₃ with R² as ethyl, propyl, pentyl, which may be interrupted by —O— or —NH—, and functionalized with an epoxide or vinyl moiety as Q1, and X as methoxy, ethoxy; and
at least one antimicrobial active ingredient, in particular at least one biocide.

Or
at least one polyol,
at least one compound of the general formula (I) according to R¹SiX₃ or R¹₂SiX₂ with R¹ as methyl, ethyl, propyl, and with X as methoxy, ethoxy;
at least one compound of the general formula (II) according to SiX₄ with X as methoxy, ethoxy; and
   at least one antimicrobial active ingredient, in particular at least one biocide.

The molar ratios of the compound of formula (I) and of formula (II) in the composition may be in a range between 0.5:10 and 10:0.5, preferably 4:1.

The molar ratios of the compound of formula (I), of formula (II) and of formula (III) in the composition may be in a range between 0.5:10:1 and 10:0.5:10, preferably 4:1:3.

As already indicated above, the antimicrobial agent used is a biocide. Preferably, no metal-containing biocide is used, in particular no biocide containing silver or zinc. The prerequisite for selecting a suitable biocide is that it complies with EU Regulation No. 528/2012 on the placing of biocidal products on the market. Biocides can be classified either according to product types such as disinfectants and protective agents or according to their target organisms (virucides, bactericides, fungicides, etc.). In the present case, the at least one biocide may be selected from a group comprising benzalkonium chloride, octylammonium chloride, chitosan, phenylphenol, 4-chloro-3-methylphenol, lactic acid, nonanoic acid, sodium benzoate, 1-[[2-(2,4-dichlorophenyl)-4-propyl-1,3-dioxolan-2-yl]methyl]-1H-1,2,4-triazoles, 2-octyl-2H-isothiazol-3-ones, thiazol-4-yl-1H-benzoimidazoles, 3-iodo-2-propynylbutylcarbamate, biphenyl-2-ol, bronopol/calcium magnesium oxide, copper (II) oxide, 2-pyridinethiol-1-oxide, Particularly preferred biocides are benzalkonium chloride, chitosan, phenylphenol, 4-chloro-3-methylphenol, biphenyl-2-ol, most preferably 4-chloro-3-methylphenol, biphenly-2-ol. The active ingredients listed originate from product families 2 and 9, which have already been approved or are in the process of being approved for antiviral flooring.

The at least one biocide may be present in the present composition in an amount (based on the amount of the composition comprising two silanes and biocide) of between 10 and 30% by weight, preferably between 15 and 25% by weight, more preferably between 18 and 23% by weight, e.g. 20% by weight or 22% by weight.

In a particularly preferred embodiment, it is provided that the present composition comprises more than one biocide, in particular at least two biocides.

It has been found that in the case of certain biocides, such as phenylphenol, high amounts of the biocide, e.g. over 20% by weight, can lead to segregation of the composition and thus to optical inhomogeneities on the surfaces.

In order to nevertheless ensure high efficacy of the antiviral additive in such cases, it has proven to be advantageous to add another biocide, such as 4-chloro-3-methylphenol, to the present composition, in particular as an admixture. In this way, segregation is avoided and good antiviral activity is ensured at the same time.

If two biocides are used, the first biocide can be used in an amount of between 15 and 25% by weight, preferably 20% by weight, and the second biocide in an amount of between 0.1 and 2% by weight, preferably between 0.3 and 0.8% by weight, particularly preferably 0.5% by weight (in each case based on the amount of the composition comprising two silanes and biocide).

In a particularly preferred variant, phenylphenol is used as the first biocide and 4-chloro-3-methylphenol as the second biocide. The amount of phenylphenol can be 20% by weight and the amount of 4-choro-3-methylphenol can be 0.48% by weight.

However, it would also be possible to use the two biocides in a weight ratio of between 1:0.5 and 1:1.5, in particular 1:1; i.e. the two biocides can be used in equal amounts, for example. The quantity ratio is controlled by the specific properties of the biocides used.

The molar ratio of silane to active ingredient can be in a range between 10 and 40 mol %, preferably 32 mol %.

In a further embodiment, the present composition may comprise inorganic particles, in particular nanoparticles based on SiO₂, such as silica gels or zeolites. The particles preferably used have a size of between 2 and 400 nm, preferably between 2 and 100 nm, more preferably between 2 and 50 nm. By adding the inorganic particles, the amount of active ingredient absorbed can be further increased.

The mass ratio between oxide from alkoxides and oxide from additional nanoparticles ranges from 1.4: to 1.26:1 to 1:2.3. Typical silica gels are silica sols such as Levasil 200 B 30, CS 30 716P, CS 20 516P. These silica sols have a depot effect and can therefore improve the effectiveness.

The present composition may be prepared in a process comprising the following steps:
Providing a mixture comprising at least one compound of the general formula (I), and at least one compound of the general formula (II);
Adding at least one catalyst, in particular an acid, to the mixture of at least one compound of the formula (I) and at least one compound of the formula (II);
Adding at least one glycol ether or one diol,
Adding at least one antimicrobial agent and heat the mixture if necessary;
if appropriate, separating the alcoholic phase formed (e.g. by evaporation) from the aqueous phase of the mixture of at least one compound of the formula (I), at least one compound of the formula (II) and the at least one antimicrobial active ingredient.

Suitable inorganic and/or organic acids as catalysts are selected from a group containing phosphoric acid, acetic acid, p-toluenesulfonic acid, hydrochloric acid, formic acid or sulfuric acid. Also suitable are ammonium salts such as ammonium sulphate, which react as weak acids. p-Toluenesulphonic acid is particularly preferred.

In the event that inorganic nanoparticles, such as silica sol, are added to the composition, these are preferably added together with the active ingredient. In one variant, however, the active ingredient can also be added with a time delay to the silica sol, e.g. after the silica sol.

The resulting suspension of the composition is stable and can be stirred into a lacquer system, in particular an alcohol-based lacquer system, as an additive and used to produce an antimicrobial surface.

However, it is also possible to dry the prepared suspension of the composition and use the resulting powder further. The powdered composition is preferably incorporated into a hot-melt adhesive.

Acrylic lacquers, PU lacquers, epoxy lacquers, silicate lacquers and/or linseed oil-based lacquers can be used as lacquer systems. The amount of antiviral component is usually in the order of 0.5-3% by weight, preferably approx. 1-2% by weight based on lacquer.

A polyurethane-based hot-melt adhesive or EVA- or PA-based hot-melt adhesives can be used.

The antimicrobially effective composition, lacquer systems or hot-melt adhesives can be used to coat substrate materials, in particular wood-based panels such as chipboard, medium density fiberboard (MDF), high density fiberboard (HDF) or oriented strand board (OSB), plywood panels, but also plastic composite panels (WPC), if applicable.

The lacquer system is typically applied to a wood-based panel using rollers, pouring heads or a spraying system, A suitable method of manufacturing a wood-based panel coated with a lacquer system containing the antiviral composition comprises the following steps:
Providing a wood-based panel that is optionally provided with a decor or veneer,
optional applying at least one lacquer layer without antiviral composition, and
Applying at least one lacquer system containing the antiviral composition, in particular a UV lacquer system.

Another suitable method of manufacturing a wood-based panel coated with a lacquer system containing the antiviral composition comprises the following steps:
Providing a wood-based panel that is optionally provided with a decor or veneer,
Applying at least one adhesive base coat, in particular a UV adhesive base coat, to at least one side of the wood-based panel,
Applying at least one further base coat, in particular a UV base coat,
Applying at least one lacquer system containing the antiviral composition, in particular a UV lacquer system.

According to one embodiment of the method, it is also possible to apply the lacquer system to a wood-based panel that is pressed with a resin-impregnated overlay paper and at least one veneer layer. In this case, an adhesive base coat, in particular a UV base coat, is first applied to the veneer layer, followed by a further base coat, in particular a UV base coat. The lacquer system, in particular the UV lacquer system, with the antiviral composition is applied to this layer structure.

After each application of the individual coats, pre-gelation (pre-curing) is carried out using UV radiation. After the last application of the antiviral lacquer system, through-curing is also carried out using UV radiation.

The wood-based panel coated with the present method, such as a chipboard panel, thus has the following layer structure:
at least one wood-based panel; and
at least one lacquer structure provided on the wood-based panel consisting of an optional lacquer layer without antiviral composition and a lacquer system with antiviral composition,

In a further embodiment, the wood-based panel coated with the present method, such as a chipboard, has the following layer structure:
at least one wood-based panel; and
at least one lacquer structure provided on the wood-based panel consisting of adhesive base coat, base coat and lacquer system with antiviral composition,

In a preferred embodiment, the coated wood-based panel, such as a chipboard panel, has the following layer structure:
at least one wood-based panel;
optionally at least one overlay paper layer;
at least one decorative layer provided on the wood-based panel, in particular in the form of a veneer layer, and
at least one lacquer structure provided on the wood-based panel consisting of an adhesive base coat, base coat and lacquer system with an antiviral composition

If the antiviral composition is incorporated into a hot-melt adhesive, this is applied to the carrier material, in particular wood-based panels, using rollers or doctor blades.

A suitable method of manufacturing a wood-based panel coated with a hot melt adhesive containing the antiviral composition comprises the following steps:
Providing a wood-based panel that is optionally provided with a decor or a veneer, and
Applying the at least one hot-melt adhesive containing the antiviral composition, in particular PUR hot-melt adhesive.

The application temperature of the hot melt adhesive depends on the melting temperature of the hot melt adhesive used. In the case of a polyurethane hot melt adhesive, for example, the application temperature can be between 13° and 170° C., preferably 150° C.

The amount of hot melt adhesive applied is between 20 and 50 g/m², preferably 30 and 40 g/m². It is also possible to apply several layers of hot melt adhesive.

The wood-based panel coated with the present method, such as a chipboard panel, thus has the following layer structure:
at least one wood-based panel; and
at least one layer of a hot-melt adhesive with an antiviral composition provided on the wood-based panel,

It is also conceivable that the coatings described contain abrasion-resistant particles. These can be applied together with the lacquer system or hot melt adhesive or sprinkled on top of them.

The abrasion-resistant particles used include, for example, particles made of corundum (aluminum oxides), boron carbides, silicon dioxides and silicon carbides. Corundum particles are particularly preferred. Preferably, these are high-grade corundum (white) with a high transparency so that the optical effect of the underlying decoration is affected as little as possible.

The quantity of abrasion-resistant particles applied, in particular scattered on, is 10 to 50 g/m², preferably 10 to 30 g/m², in particular preferably 15 to 25 g/m². The quantity of abrasion-resistant particles applied depends on the abrasion class to be achieved and the particle size. For example, in the case of abrasion class AC3, the quantity of abrasion-resistant particles is between 10 and 15 g/m², in abrasion class AC4 between 15 and 20 g/m² and in abrasion class AC5 between 20 and 35 g/m² when using grain size F200. In the present case, the finished panels preferably have abrasion class AC4.

Abrasion-resistant particles with grain sizes in classes F180 to F240, preferably F200, are used. The grain size of class F180 covers a range of 53-90 μm, F220 45-75 μm, F230 34-82 μm, F240 28-70 μm (FEPA standard). In one variant, white fused alumina F230 is used as abrasion-resistant particles.

### DESCRIPTION OF THE INVENTION

The invention is explained in more detail below with reference to examples of embodiments.

### Example 1: Additive for Silicate-Based Lacquer Systems

Prepare 19.2 g of methyltriethoxysilane and 5.6 g of tetraethoxysilane. Start the hydrolysis by adding 12.3 g deionized water and 0.8 g 37% sulphuric acid. After a stirring time of approx. 5 hours, a mixture of 3.2 g water and 7 g dipropylene glycol monomethyl ether is added. The pH value can now be adjusted to 6 by adding 2.98 g of a 10% sodium hydroxide solution. This is followed by the addition of 5.24 g biphenyl-2-ol.

The ethanol produced during the hydrolysis and condensation reaction is then removed using a rotary evaporator.

The finished additive has a flash point of over 70° C. and can now be added to any alcohol-based paint system.

Example of the production of a transparent glass-like coating with antiviral properties.

Prepare 100 g of an alcoholic SiO₂ based lacquer formulation (Ino® dur T.) Add 8.5 g of the additive described above while stirring and stir for a further 30 minutes. Application to glass or wood substrates is now carried out by spray coating, whereby a dry film thickness of approx. 20 μm is set. The subsequent compaction takes place in a convection oven at 180° C. for 15 minutes.

### Example 2: Additive for Silicate-Based Lacquer Systems

Prepare 16.2 g of methyltriethoxysilane, 6.7 g of glycidyloxypropyltriethoxysilane and 7.7 g of tetraethoxysilane. Stir 9.42 g of 4-chloro-3-methylphenol into this silane mixture and stir for approx. 30 minutes at room temperature until everything is completely dissolved. To start the hydrolysis, 14.7 g of deionized water and 1.1 g of 0.5 molar hydrochloric acid are added. After a stirring time of approx. 3 hours, a mixture of 3.9 g water and 8.2 g dipropylene glycol monomethyl ether is added.

The ethanol produced during the hydrolysis and condensation reaction is then removed using a rotary evaporator.

The finished additive has a flash point of over 70° C. and can now be added to any alcohol-based paint system.

Example of the production of a transparent glass-like coating with antiviral properties.

Prepare 100 g of an organomodified silicone resin (phenylmethyl silicone resins) from Evonik Silikophtal HTT. While stirring, 10.2 g of the additive described above is added and stirred for a further 30 minutes. Application to glass or wood substrates is now carried out by spray coating, whereby a dry film thickness of approx. 40 μm is set. The subsequent compaction takes place in a convection oven at 250° C. for 30 minutes.

### Example 3: Antiviral Flooring

An HDF (format: 2800×2070×8 mm) is coated on both sides with a veneer (0.5 mm, oak veneer on top, beech veneer on bottom) in a short-cycle press. The bonding is carried out with an overlay resin-coated with melamine. The overlay had a paper weight of 25 g/m² and a final weight with melamine resin of 150 g/m² (VC value: approx. 6.0%). The pressing time was 45 seconds, the pressing temperature 180° C. and the pressing pressure 40 bar. The cavities were then filled in layers using a 3D printer. After pressing and the cooling process, the oak veneer was coated with a lacquer system that enabled it to be used as a floor covering. The following structure was used:
1×12 g/m² UV adhesive base coat (Hesse, UG 7025)
3×18 g/m² UV base coat (Hesse, UG 7401)
1×6 g/m² UV oxyreactive oil based on linseed oil (Hesse, RO 79852) with 2% by weight antiviral active ingredient

After each application, the surface is leveled using UV radiation. After the last coat, the surface is also cured using UV radiation. In accordance with DIN EN 16511, the structure achieved service class 32 with regard to abrasion resistance.

Individual planks from the large format were fitted with an all-round profile in a flooring line, which allowed them to be laid without glue.

### Example 4: Antiviral Oiled Furniture Surface

A chipboard panel (format: 2800×2070×18 mm) is coated on both sides with a veneer (0.5 mm, cherry veneer top and bottom) in a short-cycle press. The gluing is carried out with an overlay resin-coated with melamine. The overlay had a paper weight of 25 g/m² and a final weight with melamine resin of 150 g/m² (VC value: approx. 6.0%). The pressing time was 45 seconds, the pressing temperature 180° C. and the pressing pressure 40 bar. After pressing and cooling, the cherry veneer was coated with a lacquer system that allowed it to be used as a front. The following structure was used:
1×12 g/m² UV adhesive base coat (Hesse, UG 7025)
1×18 g/m² UV base coat (Hesse, UG 7401)
1×6 g/m² UV oxyreactive oil based on linseed oil (Hesse, RO 79852) with 2% by weight antiviral active ingredient

After each application, the surface is leveled using UV radiation. After the last application, the product is also cured using UV radiation.

The large format was used to produce fixed masses for front elements in a machine line.

### Example 5: Antiviral Lacquered Furniture Surface

A chipboard panel (format: 2800×2070×18 mm) is coated on both sides with a veneer (0.5 mm, cherry veneer top and bottom) in a short-cycle press. The gluing is carried out with an overlay resin-coated with melamine. The overlay had a paper weight of 25 g/m² and a final weight with melamine resin of 150 g/m² (VC value: approx. 6.0%). The pressing time was 45 seconds, the pressing temperature 180° C. and the pressing pressure 40 bar. After pressing and cooling, the cherry veneer was coated with a lacquer system that allowed it to be used as a front. The following structure was used:
1×12 g/m² UV adhesive base coat (Hesse, UG 7025)
1×18 g/m² UV base coat (Hesse, UG 7401)
1×6 g/m² UV excimer top lacquer (UX 113333-22010 from Hesse) with 2% by weight antiviral active ingredient

After each application, the surface is leveled using UV radiation. After the last application, the product is also cured using UV radiation.

This produced a surface with a gloss level of 5 gloss points in accordance with DIN EN ISO 2813 (2015-02: Coating materials—Determination of gloss level at 20°, 60° and 85°), measuring angle 85°.

The large format was used to produce fixed masses for front elements in a machine line.

### Example 6: Oiled Wood Veneer Surface

A chipboard panel (format: 2800×2070×18 mm) is coated on both sides with a wood veneer 0.5 mm, cherry veneer top and bottom) in a short-cycle press. The bonding is carried out with an overlay resin-coated with melamine. The overlay had a paper weight of 25 g/m² and a final weight with melamine resin of 150 g/m² (VC value: approx. 6.0%). The pressing time was 45 seconds, the pressing temperature 180° C. and the pressing pressure 40 bar. After pressing and cooling, the cherry veneer was coated with a lacquer system that allowed it to be used as a front. The following structure was used:
1×17 g/m² UV oxyreactive oil
1×6 g/m² UV oxyreactive oil with 2% by weight antiviral component

After each application, the surface is leveled using UV radiation. After the last application, the product is also cured using UV radiation.

This produced a surface with a gloss level of 5 gloss points in accordance with DIN EN ISO 2813 (2015-02: Coating materials—Determination of gloss level at 20°, 60° and 85°), measuring angle 85°.

The large format was used to produce fixed masses for front elements in a machine line.

### Example 7: Additive for Polyurethane System (Hotmelt)

To incorporate the additive into a 100% PUR hotmelt system, the additive is incorporated into a polyol, which is then processed into the finished PUR hotmelt system in a further step.

### Production of the Modified Polyol:

Preparation of 3.56 g methyltriethoxysilane and 20.8 g tetraethoxysilane. Start the hydrolysis by adding 8.28 g of deionized water and 4.2 g of an ion exchanger (Levatit 2629). After a stirring time of approx. 4 hours, the ion exchanger is sieved off and a mixture of 2.8 g water and 16.9 g polybutadiene diol (Krasol LBH 2000) is added. Subsequently, 5.24 g of biphenyl-2-ol is added and the entire mixture is heated at 50° C. for a further 2 hours under reflux. The alcohol produced during hydrolysis is then removed using a rotary evaporator (50° C., 100 mbar) The finished polyol-modified additive has a flash point of over 70° C. and can now be added to other polyols (e.g. Krasol LBH 2000). This polyol can now be used to produce the PUR hot melt.

### Example 8: Powder Additive for Addition to any Polymer System (e.g. Polyurethane System or Polyethylene Terephthalate)

The use of a powdered additive is also helpful for incorporating the additive into various polymers, which can then be incorporated into a wide variety of matrices using a hot kneader, for example.

### Production of the Modified Polyol:

Preparation of 3.56 g methyltriethoxysilane and 20.8 g tetraethoxysilane. Start the hydrolysis by adding 8.28 g of deionized water and 4.2 g of an ion exchanger (Levatit 2629). After a stirring time of approx. 4 hours, the ion exchanger is sieved off. Now 5.24 g of biphenyl-2-ol is added to the mixture and the entire mixture is heated under reflux at 50° C. for a further 2 hours. The entire additive is then dried to dryness (2 hours) in a crystallization dish at 75° C. in a drying oven. The resulting cake is crushed and ground and dried at 75° C. for a further 2 hours. The dry additive is then ground dry to the desired particle size using a bead mill.

The resulting powder can now be added to a plastic by stirring, kneading or extrusion.

### Antiviral Tests:

The antiviral compositions were tested for their antiviral activity in accordance with ISO 217022:2019-05 “Measurement of antiviral activity on plastic and other non-porous surfaces”.

The results showed antiviral activity for embodiments 2-7 with respect to bacteriophage MS2 (DSM 13767) with a log 10 PFU of 3 and above. E.g. for embodiment 7 with a log 10 PFU of more than 4.

1. A composition having antimicrobial properties, in particular antiviral properties, as an additive for transparent surface coatings of decorated substrates, the composition comprising:
at least one polyol or one glycol ether;
at least one compound of the general formula (I)
R¹ₐSiX₍₄₋ₐ₎ (I),
whereby
X is alkoxy, and
R¹ is an organic moiety selected from the group consisting of alkyl cycloalkyl or phenyl, and
a=1, 2, 3, in particular 1 or 2,
at least one compound of the general formula (II)
SiX₄ (II),
where X is alkoxy, and
at least one antimicrobial active ingredient, in particular at least one biocide.

2. The composition according to claim 1, further comprising,
at least one compound of the general formula (III)
R²SiX₃ (III),
whereby
X is alkoxy, and
R² is an organic moiety selected from the group comprising C1-C10 alkyl, which may be interrupted by —O— or —NH—, and
wherein R¹ comprises at least one functional group Q₁ selected from a group comprising a methacrylic, methacryloxy, vinyl and epoxy group.

3. The composition according to claim 1, wherein X is selected from a group comprising C₁₋₆-alkoxy, in particular methoxy, ethoxy, n-propoxy, i-propoxy and butoxy.

4. The composition according to claim 1, wherein R¹ of the compound of the general formula (I) is selected from a group comprising C1-C10 alkyl, preferably C1-C8 alkyl, in particular preferably methyl, ethyl, propyl, pentyl, hexyl, heptyl, octyl.

5. The composition according to claim 1, wherein R² of the compound of the general formula (III) is selected from a group comprising methyl, ethyl, propyl, pentyl, hexyl, heptyl, octyl, which may be interrupted by —O— or —NH—.

6. The composition according to claim 1, wherein the at least one functional moiety Q¹ of the compound of the general formula (III) is selected from a group comprising epoxide, amino and vinyl group.

7. The composition according to claim 1, wherein the glycol ether used is dipropylene glycol monomethyl ether, tripropylene glycol monomethyl ether, 1-methoxy-2-propanol, tripropylene glycol monobutyl ether, propylene glycol butyl ether, ethylene glycol monophenyl ether.

8. The composition according to claim 1, wherein the polyol used is polybutadiene diol, polyethylene glycol, polypropylene glycol, propane-1,2,3-triol.

9. The composition according to claim 1, wherein the at least one biocide is selected from a group comprising disinfectants and protective agents, in particular comprising benzalkonium chloride, chitosan, phenylphenol, copper sulphate.

10. The composition according to claim 1, further comprising inorganic particles, in particular nanoparticles, preferably based on SiO₂ (silica sol, zeolites).

11. A lacquer for coating substrates comprising a composition according to claim 1.

12. A hot melt adhesive for coating substrates comprising a composition according to claim 1.

13. (canceled)

14. A wood-based panel coated with at least one composition according to claim 1.

15. A wood-based panel coated with a lacquer according to claim 11.

16. A wood-based panel coated with a hot-melt adhesive according to claim 12.
